(19) United States
(12) Patent Application Publication
(10) Pub. No.: US 2007/0034472 A1
(43) Pub. Date: Feb. 15, 2007

(54) Clutch, particularly for motorcycles

(76) Inventor: Vito Strada, Chieri (IT)

Correspondence Address: Modiano & Associati, Via Meravigli 16, Milano, 20123, IT

(21) Appl. No.: 10/578,518

(22) PCT Filed: Nov. 19, 2003
(86) PCT No.: PCT/IT03/00752

§ 371 Date: May 8, 2006

(51) Int. Cl. F16D 11/06

(52) U.S. Cl. 192/52.5

(57) ABSTRACT

A clutch for vehicles comprises a driving member (10) and a driven member (22) coaxial to the driving member, with a pack of clutch plates between them which are alternatively connected to the driving member and to the driven member, a pressure member (38) engaged by elastic means (44) to push the clutch plates against a ledge (10b) of the driven member, a floating member (20) that is axially translatable between the driven member (10) and the pressure member (38), and driving means (22, 24, 26) on said driving member and floating member which are in mutual, rotary and shifting engagement to axially push the floating member (20) against the pressure member in contrast to said elastic means. The driving means comprises rollers (22) each pivotally supported by the driving member (10) about a substantially radial axis to engage respective inclines (26s) that are frontally made on the floating member.

The present invention relates to a clutch for vehicles, particularly for motorcycles.

For a gradual transmission of the driving torque to the driveline, the clutches make use of two, mutually linked sets of clutch plates which are respectively connected to a driving member and to a driven member, by pressing and releasing the plates by means of a Belleville washer that is supported on the driving member and whose peripheral edge engages a counter-ledge of the driven member.

Moreover, when shifting down gear, particularly in high-performance vehicles such as sport motorcycles, rapid torque reverses are generated with high differentials which may cause the engine to be overloaded up to breaking. Therefore, prior European Patent Application No. 97 122 156.9 describes a friction clutch for motorcycles which is provided with a device providing the automatic clutch disengagement as soon as a maximum inverse-torque threshold is reached. Such device makes use of balls engaged between inclines to disengage the members of the friction clutch as soon as a predetermined inverse-torque threshold is exceeded. The threshold is adjustable by changing features such as the inclination of the planes, the elastic coefficient of the spring, etc.

Although the clutch of the above-mentioned European document effectively performs its function of limiting the inverse torque to a predetermined threshold, however, in particular operative conditions, mainly in presence of wear of the rolling surfaces, it is liable to jamming because the balls, which are free to roll between the inclines, may escape from their tracks and become seized between the driving member and the driven member.

Therefore, a main object of the present invention is to provide a clutch, particularly for motorcycles, which is provided with an automatic, clutch-disengaging device that is improved with respect to the above-mentioned, prior device in order to prevent jamming.

The above mentioned object and other aims and advantages, which will better appear below, are achieved by a clutch having the features recited in claim 1, while the dependent claims state other advantageous, though non-essential features.

The invention will now be described in more detail with reference to a preferred, non-exclusive embodiment, shown by way of non-limiting example in the attached drawings, wherein:

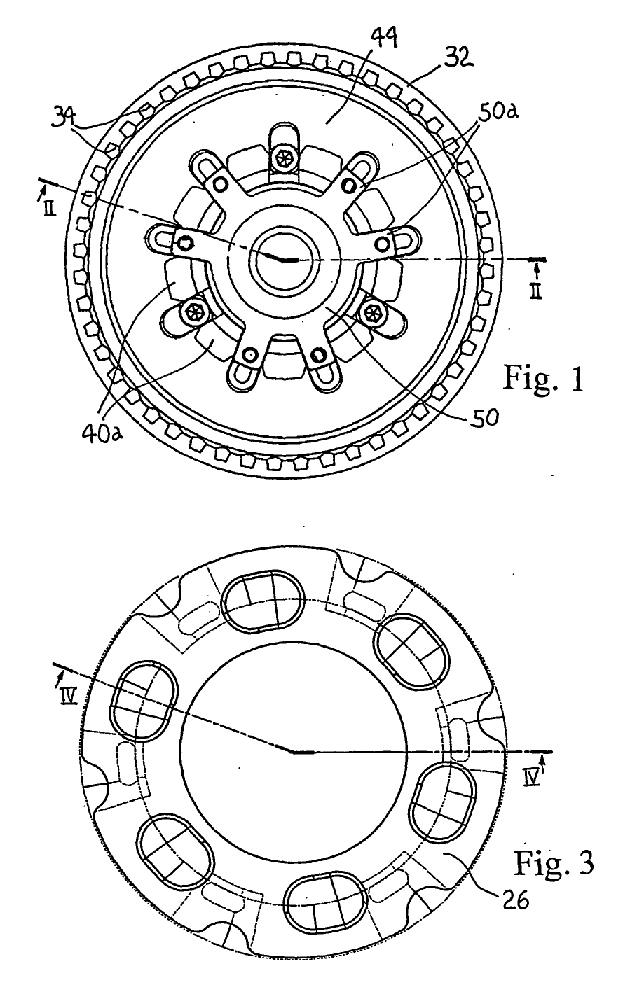

FIG. 1 is a front view of the clutch for motorcycles according to the invention;

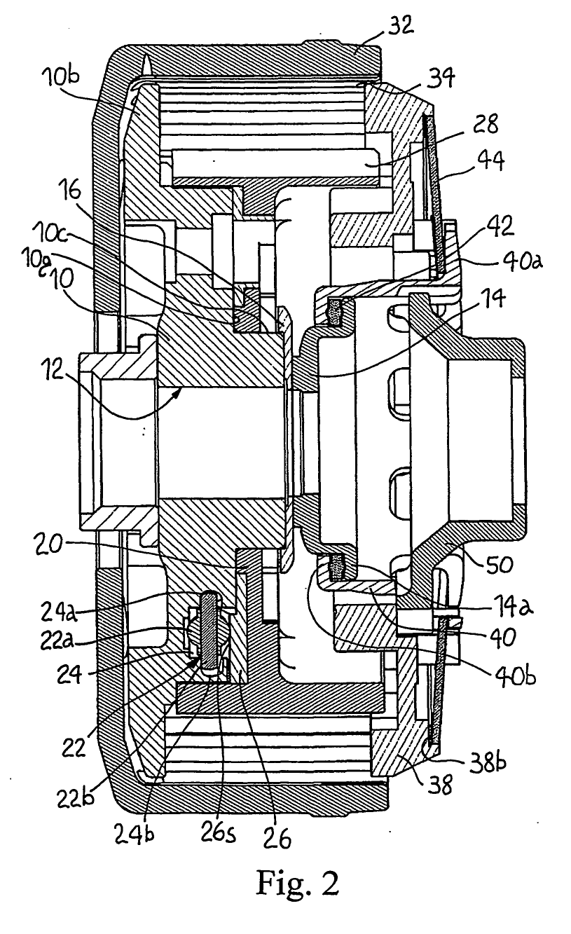

FIG. 2 is a cross-section view along line II-II and to an enlarged scale of the clutch of FIG. 1;

FIG. 3 is a front view to an enlarged scale of a detail of the clutch of FIG. 1;

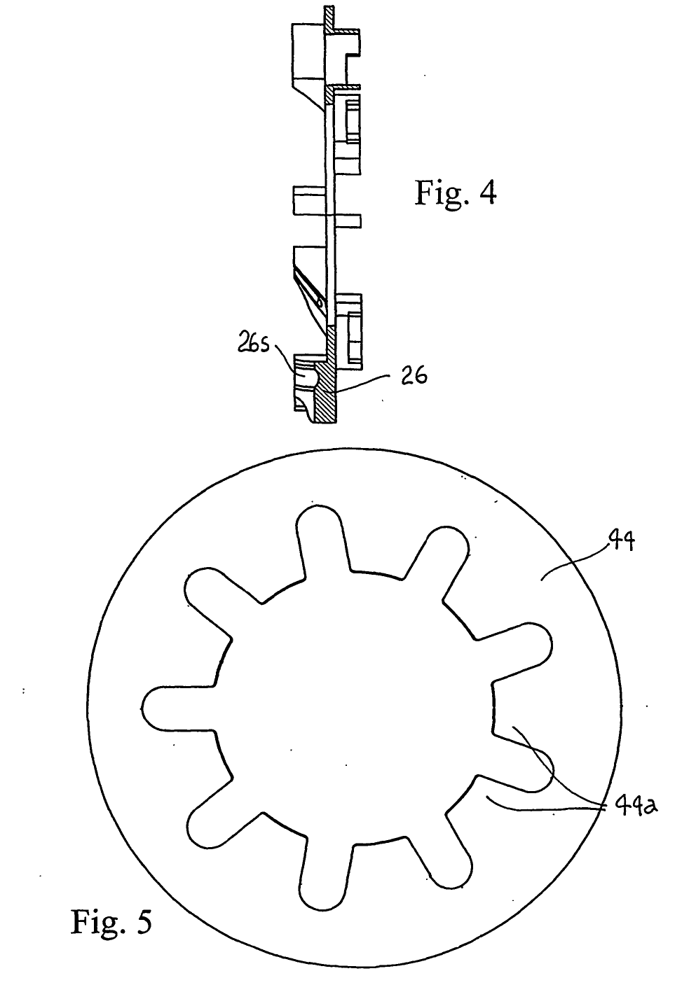

FIG. 4 is a cross-section view along line IV-IV of the detail of FIG. 3;

FIG. 5 is a front view of a further detail of the clutch.

With reference to the above-mentioned figures, a friction clutch comprises a hub 10 having an axial, cylindrical housing 12 to be keyed, in a way known per se, onto a driving shaft (not shown) together with a counter-hub 14 and a ring 16 between them.

An axially slidable cylinder 20 is pivotally supported on a cylindrical seat 10c of hub 10 and, according to this invention, is coupled with hub 10 via rollers 22. Rollers 22 are pivotally supported about a radial axis in respective, equally spaced slots 24 made on a plate 10b of hub 10 and engage respective inclines 26s made on a steel plate 26 that is frontally laid on cylinder 20.

Each roll consists of a ball 22a that is diametrically supported by a pin 22b whose ends are pivotally engaged in holes 24a, 24b made on the side walls of slot 24. Cylinder 20 is elastically butted against hub 10 by means of an elastic member (not shown) compressed between ring 16 and the hub.

The perimeter of hub 20 has longitudinal grooves 28 which are engaged, in a known way, by respective internal toothing of driving clutch plates (not shown). A basket-shaped, driven member 32 is pivotally supported around hub 10 and cylinder 20 and has channels such as 34 which are engaged by driven clutch plates (not shown), which are alternated with the driving plates to form a pack of plates that are alternatively connected to hub 20 and basket 32.

The pack of plates is axially constrained between a ledge 10b of the hub and a plate-pushing cap 38 that is externally provided with a circumferential ledge 38b having an hardened coating on the opposite side of the surface in contact with the plates.

Counter-hub 14 has an external ledge 14a engaged by a thrust ball-bearing 42 consisting in a know way of a crown of balls constrained in a cage. A sleeve 40 has an abutment 40b which pushes ball-bearing 42 against the external ledge 14a of the counter-hub and, at the opposite end, sleeve 40 has a plurality of radial claws 40a. A spider spring 44 is constrained between the circumferential ledge 38b of cap 38 and the claws 40a of the sleeve. Spider spring 44 consists of a conical plate of sheet steel having a central hole and cut with radial slots to form a plurality of radial fongers such as 44a which are engaged by claws 40a.

A conical member 50 that is coaxial to cap 34 has a plurality of radial brackets such as 50a which project between claws 40a of sleeve 40 and are screwed to cap 34. The conical member is normally in a resting position, and can be pushed or pulled rightward (as seen in FIG. 1) by means of known means (not shown) against spider spring 44 for withdrawing cap 38 from the pack of plates, thereby disengaging the clutch.

The set of rollers 22 housed in the slots 24 engages disc 26 to form an automatic clutch-disengaging device operating as soon as maximum inverse torque threshold is reached, which is similar in its operation to the known device described in the prior, above-mentioned European document. As soon as a predetermined inverse-torque threshold is exceeded, rollers 22 roll along their respective inclines 26s causing cylinder 20 to be axially withdrawn from hub 10, to abut against pressing cap 38 and to move the latter away from the pack of plates in opposition to spider spring 44, thereby causing the clutch disengagement. The threshold required to cause the disengagement is adjustable in a known way by changing features such as the inclination of the planes, the elastic coefficient of the spring, etc.

Since rollers 22 are constrained to rotate in association with the hub, any jamming is prevented while it could occur in case of balls free to roll between inclines, should one or more balls escape. Furthermore, since the inclines are made on a steel plate laid on the cylinder and made of an aluminium alloy for reduction of weights, wear is reduced a longer mechanical life for the device is achieved.

A preferred embodiment of the invention has been described, but of course many changes may be made by a person skilled in the art, depending on the requirements, within the scope of the inventive concept. For example, rollers 22 can be made enbloc and the inclines can be directly made on the cylinder, should it be made of a wearproof material.

1. A friction clutch for vehicles, comprising a driving member (10) and a driven member (22) coaxial to the driving member, with a pack of clutch plates between them which are alternatively connected to the driving member and to the driven member, a pressure member (38) engaged by elastic means (44) to push the clutch plates against a ledge (10b) of the driven member, a floating member (20) that is axially translatable between the driven member (10) and the pressure member (38), and driving means (22, 24, 26) on said driving member and floating member which are in mutual, rotary and shifting engagement to axially push the floating member (20) against the pressure member in contrast to said elastic means, characterized in that said driving means comprise rollers (22) each pivotally supported by one of said driving member (10) and floating member (20) about a substantially radial axis to engage respective inclines (26s) that are frontally made on the other one of said driving member and floating member.

2. The friction clutch of claim 1, characterized in that said rollers (22) are pivotally supported on said driving member.

3. The friction clutch of claim 1 or 2, characterized in that each roller has a substantially spherical, middle portion (22a) and two opposite, diametrical ends.

4. The friction clutch of claim 3, characterized in that said substantially spherical, middle portion (22a) is diametrically supported on a pin (22b) and said opposite, diametrical ends are the ends of the pin.

5. The friction clutch of anyone of claims 2 to 4, characterized in that said rollers (22) are arranged in respective, equally spaced slots (24) made on the driving member and said opposite, diametrical ends are engaged in holes (24a, 24b) made on the side walls of the slot.

6. The friction clutch of anyone of claims 2-5, characterized in that said inclines (26s) are made on a plate member (26) that is made of a wearproof material and is frontally laid on the floating member (20).

7. The friction clutch of anyone of claims 1 to 6, where that said pressure member consists of a cap (38) having an annular surface adapted to engage said clutch plates, characterized in that said elastic means consist of a spider spring (44) having a smaller base that is axially retained by retaining means (40) and a larger base that is elastically abutted against a circumferential abutment (38b) of the cup (38) on the opposite side of the annular surface.

8-14. (canceled)
